(19) United States
(12) Patent Application Publication
(10) Pub. No.: US 2005/0221143 A1
(43) Pub. Date: Oct. 6, 2005

(54) Proton conductor

(76) Inventors: Kyung-jung Kwon, Seoul (KR); Masaya Yano, Oura-gun (JP); Hee-young Sun, Yongin-si (KR); Jung-ook Park, Yongin-si (KR)

Correspondence Address: MCGUIREWOODS, LLP, 1750 TYSONS BLVD, SUITE 1800, MCLEAN, VA, 22102, US

(21) Appl. No.: 11/097,296

(22) Filed: Apr. 4, 2005

(30) Foreign Application Priority Data
Apr. 3, 2004 (KR) 10-2004-0023174

(51) Int. Cl. H01M 8/10; C25C 7/04; C25B 13/00; C01G 17/02; C01G 19/02; C01G 21/02

(52) U.S. Cl. 429/33; 204/295; 423/594.9

(57) ABSTRACT

The present invention provides a proton conductor comprising SnP₂O₇. The present invention also provides a fuel cell that comprising a cathode, an anode, and an electrolyte membrane, in which one of these components comprises SnP₂O₇. The SnP₂O₇ has high ionic conductivity of about 10⁻¹ to 10⁻² S/cm at about 80° C. or greater when non-humidified. In addition, SnP₂O₇ is water-insoluble, and stable at high temperatures. These properties make SnP₂O₇ suitable to act as a non-humidified proton conductor, or a high temperature non-humidified proton conductor.

### CROSS-REFERENCE TO RELATED PATENT APPLICATIONS

This application claims the benefit of and priority to Korean Patent Application No. 10-2004-0023174, filed on Apr. 3, 2004, in the Korean Intellectual Property Office, the disclosure of which is incorporated herein in its entirety by reference for all purposes as if fully set forth herein.

### BACKGROUND OF THE INVENTION

1. Field of the Invention

The present invention relates to a proton conductor and a fuel cell including the same. In particular, the present invention relates to a proton exchange membrane fuel cell (PEMFC).

2. Description of the Related Art

Fuel cells produce electricity by a chemical reaction between fuel and oxygen. Fuel cells are classified into categories including polymer electrolyte membrane fuel cells, phosphoric acid fuel cells (PAFCs), molten carbonate fuel cells (MCFCs), and solid oxide fuel cells (SOFCs), depending on the type of electrolyte used. The type of electrolyte affects the operating temperatures and components of fuel cells.

A PEMFC includes a proton conductive polymer electrolyte membrane as its electrolyte. Typically, the PEMFC includes an anode (fuel electrode), a cathode (oxidant electrode), and a polymer electrolyte membrane disposed between the anode and the cathode. The anode of the PEMFC includes a catalyst layer that promotes the oxidation of fuel. The cathode of the PEMFC includes a catalyst layer that promotes the reduction of an oxidant.

Typically, the anode is supplied with a fuel, such as hydrogen, a hydrogen-containing gas, a gas mixture of methanol and water, a methanol solution, and the like. The cathode is supplied with an oxidant, such as oxygen, an oxygen-containing gas, or air.

Hydrogen ions and electrons are generated by oxidizing the fuel at the anode of a PEMFC. The hydrogen ions migrate to the cathode through the electrolyte membrane. The electrons migrate to an external circuit (load) through a conducting line or a collector. The hydrogen ions then combine with the electrons and oxygen to produce water. The flow of electrons through the anode, the outer circuit, and the cathode generates electricity.

The polymer electrolyte membrane of the PEMFC acts as an ion conductor for transporting hydrogen ions from the anode to the cathode, as a separator for mechanically separating the anode and the cathode, and as an electron insulator. In order to put PEMFCs to practical use, the development of an inexpensive electrolyte membrane with high proton conductivity is a prerequisite.

Polymer electrolyte membranes are commonly composed of, for example, sulfonate perfluorinated polymer such as Nafion® that has a backbone comprising a fluorinated alkylene and a side chain comprising fluorinated vinyl ether with a fluorinated acid group at its terminal. Such a polymer electrolyte membrane exhibits excellent ion conductivity by retaining a sufficient amount of water.

In a PEMFC that includes a polymer electrolyte membrane, protons generated at the anode migrate to the cathode while carrying water because of osmotic drag. As a result, the anode becomes dry, thus substantially decreasing the proton conductivity of the polymer electrolyte membrane. In addition, when the PEMFC operates at about 80 to 100° C., the water that is retained in the polymer electrolyte membrane evaporates, thus drying the polymer electrolyte membrane. The loss of water in the polymer electrolyte membrane results in a decrease in the proton conductivity of the polymer electrolyte.

In order to solve these problems, the PEMFC can be humidified with an external fuel stream or an external air stream, as shown in U.S. Pat. No. 4,530,886 and JP Patent No. 2001-216,982, which describe an indirect external humidifying method. However, this indirect external humidifying method may have disadvantages. For example, this method enlarges the PEMFC increases in size, and the start-up performance and response of the PEMFC for varying loads deteriorates. Further, when the PEMFC operates with a heavy load, the PEMFC's performance deteriorates due to the presence of excess water in the system.

Alternatively, the polymer electrolyte membrane can be humidified by decreasing the thickness of the polymer electrolyte membrane. The thinner membrane allows water generated in the cathode to diffuse to it, thus preventing the polymer electrolyte membrane from drying out. However, since the polymer electrolyte membrane is thin, the crossover of reacting gases also occurs.

In order to keep the electrolyte membrane from drying out and to prevent the crossover of reacting gases, a self-humidifying electrolyte membrane has been developed (see U.S. Pat. Nos. 5,766,787 and 5,472,799). The self-humidifying electrolyte membrane contains a small number of ultrafine Pt particles and ultrafine oxide particles, such as TiO₂, SiO₂ that act as a catalyst. In this type of membrane, hydrogen and oxygen react to produce water over the Pt catalyst. The water is adsorbed by the oxide ultrafine particles, resulting in self-humidification of the electrolyte membrane.

Conventionally, a PEMFC operates at 100° C. or less, for example, at about 80° C., in order to prevent the drying out of the polymer electrolyte membrane. However, an operating temperature of about 100° C. or less causes many problems. For example, hydrogen-rich fuel gas is generated by reforming an organic fuel such as natural gas or methanol, which generates CO₂ and CO as byproducts. The CO poisons the catalysts contained in the cathode and the anode, which, in turn, decreases the catalyst's activity. The CO poisoning may be exacerbated at low operating temperatures. Thus, the operating efficiency and lifespan of the PEMFC are significantly decreased at low operating temperatures.

In addition, the CO poisoning may occur when methanol is used to fuel the PEMFC. Methanol is supplied to the anode of the PEMFC as a liquid methanol solution or as a gaseous mixture of water and methanol. The methanol and water react at the anode, thus producing hydrogen ions and electrons, as well as CO and CO₂ as byproducts.

When the PEMFC operates at about 150° C. or greater, the CO poisoning can be prevented and the temperature changes in the PEMFC can easily be controlled. Using a miniaturized fuel reformer and a simplified cooling device, the size of the PEMFC can be decreased. Due to these advantages, PEMFCs that can operate at high temperatures are highly desirable.

In order to prevent the drying out of the polymer electrolyte membrane when operating the PEMFC at high temperatures, non-humidified electrolyte membranes (do not contain water), have been developed, replacing humidified polymer electrolyte membranes.

In addition to a polymer electrolyte, a proton conductive inorganic compound can be used to form the non-humidified electrolyte membrane. Therefore, the acronym PEMFC can also refer to a “proton exchange membrane fuel cell” as well as a “polymer electrolyte membrane fuel cell.”

The non-humidified polymer electrolyte membrane may include, but is not limited to, a polybenzimidazole/strong acid composite, a polytyramine/strong acid composite, or a base polymer/acid polymer composite, a polytetrafluoroethylene porous electrolyte membrane formed by processing thereof, and an electrolyte membrane enforced with apatite (see U.S. Pat. Nos. 5,525,436, 6,187,231, 6,194,474, 6,242,135, 6,300,381, and 6,365,294).

The proton conductive inorganic compound may include a hydrated inorganic compound such as CsHSO₄, or Zr(HPO₄)₂, for example (see U.S. Pat. Nos. 4,594,297 and 5,932,361). Most of the hydrated inorganic compounds must contain sufficient water in order to have excellent ionic conductivity.

Although CsHSO₄ is a non-humidified proton conductor that does not form a hydrate, CsHSO₄ is not suitable for a fuel cell because it is crystalline and water-soluble.

Zr(HPO₄)₂ is proton conductive when it is in an anhydrous state. However, the ionic conductivity of Zr(HPO₄)₂ is about 10⁻⁶ S/cm at 120° C., which is insufficient for use in a PEMFC.

### SUMMARY OF THE INVENTION

The present invention provides a proton conductor that comprises SnP₂O₇. SnP₂O₇ has an ionic conductivity of about 10⁻² to 10⁻¹ S/cm at about 80° C. or more when it is non-humidified. In addition, SnP₂O₇ is water-insoluble and stable at high temperatures.

These properties make SnP₂O₇ a suitable ionic conductor for various electrochemical devices such as an electrolyte membrane of a proton exchange membrane fuel cell. In particular, it is well-suited as a non-humidified proton conductor or a high temperature non-humidified proton conductor. The proton conductor comprising SnP₂O₇ according to an exemplary embodiment of the present invention can be used in other electrochemical devices, such as an electrochemical sensor, a water electrolysis device, in addition to being used in a fuel cell.

Additional features of the invention will be set forth in the description which follows, and in part will be apparent from the description, or may be learned by practice of the invention.

The present invention discloses a proton conductor that comprises SnP₂O₇.

The present invention also discloses a fuel cell that includes a cathode, an anode, and an electrolyte membrane. In this fuel cell, at least a component of the fuel cell such as the cathode, the anode, and the electrolyte membrane contains SnP₂O₇.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates x-ray diffraction (XRD) data of a powder prepared in Example

FIG. 2 is a graph of ionic conductivity with respect to the temperature of proton conductors prepared in Example 1 and a Comparative Example.

FIG. 3 is a graph of ionic conductivity with respect to the temperature of proton conductors prepared in Examples 1 to 3.

### DETAILED DESCRIPTION OF THE INVENTION

The present invention relates to a proton conductor that comprises SnP₂O₇. In addition, the present invention relates to a fuel cell that comprises SnP₂O₇ in its cathode, anode, or electrolyte membrane.

A method of preparing SnP₂O₇ for use as a proton conductor includes reacting SnO₂ or SnO₂ hydrate with a phosphoric acid and heat-treating the reaction product.

SnO₂ or SnO₂ hydrate may be denoted as SnO₂.xH₂O where x ranges from 0 to 4, preferably 0 to 2, but is not limited thereto.

The concentration of phosphoric acid may range from about 80 wt % to 115 wt %. When the concentration of the phosphoric acid is less than about 80 wt %, it is very difficult to produce SnP₂O₇. When the concentration of the phosphoric acid is greater than 115 wt %, the time required for the heat treatment increases.

The weight ratio of SnO₂ to H₃PO₄ may be in the range of about 1:3 to about 1:1. When this ratio is less than about 1:3, the heat treatment must be performed for a longer amount of time in order to evaporate the residual unreacted phosphoric acid. When the ratio exceeds about 1:1, it becomes difficult to produce SnP₂O₇.

When reacting the SnO₂ or SnO₂ hydrate with the phosphoric acid, the temperature may range from about 150° C. to 450° C. When the temperature is less than about 150° C., the time required to evaporate the residual unreacted phosphoric acid increases. When the temperature exceeds about 450° C., the structure of the SnP₂O₇ changes. The reaction time can be selected depending on the reaction temperature, so that the reaction is sufficiently completed.

The product of the SnO₂ hydrate and the phosphoric acid reaction is heat-treated to produce a SnP₂O₇ powder. The temperature of the heat treatment may range from about 500° C. to about 800° C. When the temperature is less than about 500° C., the phosphoric acid does not evaporate and it becomes difficult to form SnP₂O₇. When the temperature exceeds about 800° C., the structure of the SnP₂O₇ changes.

The SnP₂O₇ may be heat-treated for about 1 to 3.5 hours. When the duration of the heat treatment is outside of this range, the ionic conductivity of the SnP₂O₇ decreases.

The present invention also provides a fuel cell comprising SnP₂O₇. The fuel cell according to an embodiment of the present invention includes a cathode, an anode, and an electrolyte membrane disposed in between the cathode and anode. At least one of the cathode, anode, and electrolyte membrane comprises SnP₂O₇.

A method of fabricating a proton conductor comprising SnP₂O₇ according to an exemplary embodiment of the present invention will now be described. An electrolyte membrane comprising such a SnP₂O₇ proton conductor can be used in a solid oxide fuel cell (SOFC) and the PEMFC.

When used in the SOFC, a proton conductor comprising SnP₂O₇ can be prepared by forming SnP₂O₇ into pellets and heat-treating the pellets at about 800° C. to about 1300° C. Alternatively, the proton conductor comprising SnP₂O₇ can be prepared by heat treating SnP₂₀₇ powder at about 500° C. to about 800° C., for example, and pelletizing the heat-treated SnP₂O₇.

When used in the PEMFC, a proton conductor comprising SnP₂O₇ can be prepared by first pulverizing SnP₂O₇ using a pulverizing method, such as using a Ball Mill. Next, the pulverized SnP₂O₇ powder is mixed with a binder resin, such as a fluorinated perfluorinated polymer and formed into a membrane. In this case, the proton conductor may comprise about 50% to about 95% SnP₂O₇ by volume. When the proton conductor comprises less than about 50% SnP₂O₇ by volume, the conductivity of the electrolyte membrane may decrease. When the proton conductor comprises more than about 95% SnP₂O₇ by volume, it is difficult to form a membrane from the mixture of SnP₂O₇ and the binder resin.

An electrode catalyst layer of a fuel cell may also comprise SnP₂O₇ which can act as an ion conductor through which ions migrate from a catalyst contained in the catalyst layer to an ion conducting layer of the fuel cell.

The electrode catalyst layer comprising SnP₂O₇ may be formed using a slurry. The slurry is prepared by adding SnP₂O₇ powder to a conventional catalyst layer-forming slurry, and performing the conventional methods of forming a catalyst layer on an electrode. The catalyst layer of the fuel cell may comprise about 20% to 60% SnP₂O₇ by volume. When the catalyst layer comprises less than about 20% by volume of SnP₂O₇, the proton conductivity of the catalyst layer may decrease. When the catalyst layer comprises more than about 60% by volume of SnP₂O₇, the gas permeability of the catalyst layer may decrease.

Hereinafter, the present invention will be described in detail with reference to the following examples. These examples are for illustrative purposes only, and are not intended to limit the scope of the present invention.

### EXAMPLE 1

### Preparation of SnP₂O₇

An aqueous ammonia solution was dripped into an aqueous SnCl₄ solution, to produce Sn(OH)₄. The Sn(OH)₄ was washed with water, filtered, dried at 80° C. for 5 hours, dried again at 130° C. for 5 hours, and heat-treated at 550° C. for 2 hours. As a result, SnO₂ or SnO₂ hydrate represented by SnO2.xH₂O where x is in the range of 0 to 4 was synthesized.

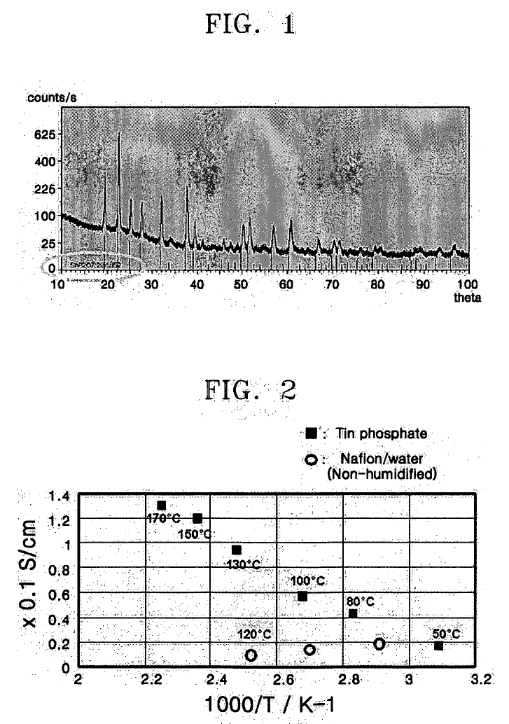

The SnO₂.xH₂O and 105 wt % phosphoric acid (obtained from Rasa Industries, Ltd. of Japan) were mixed in a weight ratio of 1:2 and stirred at 350° C. for 3 hours. The resulting mixture was heat treated at 650° C. for 2 hours, to form a powder. The powder was identified using x-ray diffraction (XRD). The results are shown in FIG. 1. Based on the pattern illustrated in FIG. 1, it was confirmed that the power was SnP₂O₇.

### EXAMPLES 2 And 3

### Preparation of SnP₂O₇

Two SnP₂O₇ samples were prepared in the same manner as in Example 1, except that the mixture of SnO₂.xH₂O and 105 wt % phosphoric acid were heat treated at 650° C. for 1 hour and 3.5 hours, respectively.

Ionic Conductivity of SnP₂O₇ Pellet

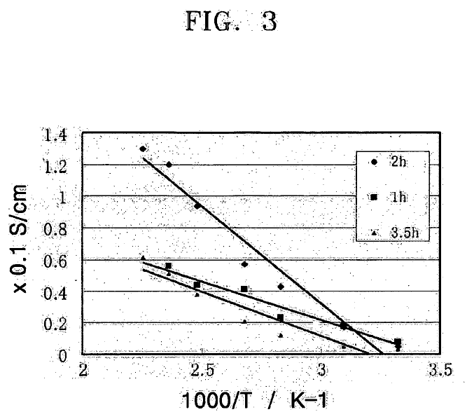

The SnP₂O₇ powders prepared in Examples 1 to 3 were pressed at a pressure of about 45 MPa to form pellets that have a cross-sectional area of 3.14 cm² and a thickness of 1 to 2 mm. The ionic conductivity of the SnP₂O₇ pellets with respect to temperature was measured using a 4-probe conductivity measuring device. The temperature was changed from room temperature to 170° C. under a frequency of 100 KHz to 1 Hz, a voltage of 100 mV. The results are shown in FIGS. 2 and 3.

### COMPARATIVE EXAMPLE

### Ionic Conductivity of Nafion 117®

Nafion 117® was immersed for 1 hour in a liquid mixture of 20 ml of 30 wt % aqueous hydrogen peroxide and 200 ml of distilled water, and then dried at 80° C. for 1 hour. The resulting Nafion 117® was immersed for 1 hour in a mixed liquid of 5.42 ml of 98 wt % sulfuric acid and 200 ml of distilled water, and then dried at 80° C. for 1 hour. The resulting Nafion 117® was washed with distilled water, and then dried at 80° C. for 1 hour. The washed Nafion 117® was dried in a vacuum oven at 105° C. for 1 hour, and then immersed in distilled water at 80° C. for 1 hour, thus producing humidified Nafion 117®. The ionic conductivity with respect to temperature of the humidified Nafion 117® was measured. The results are shown in FIG. 2.

FIG. 2 is a graph of ionic conductivity with respect to temperature of the SnP₂O₇ pellet prepared according to Example 1 and Nafion 117® prepared according to Comparative Example 1. Referring to FIG. 2, when the temperature increased from 50° C. to 170° C., the ionic conductivity of the SnP₂O₇ pellet increased, but the ionic conductivity of Nafion 117® decreased. In addition, the SnP₂O₇ pellet showed much better ionic conductivity than Nafion 117® when temperature was in the range of 80 to 170° C. Further, even when the temperature was in the range of 50 to 80° C., the ionic conductivity of the SnP₂O₇ pellet was equal to or greater than the ionic conductivity of Nafion 117®. Therefore, it was confirmed that the proton conductor containing SnP₂O₇ according to an embodiment of the present invention acts as an excellent non-humidified proton conductor at both high and low temperatures.

FIG. 3 is a graph of ionic conductivity with respect to temperature of SnP₂O₇ pellets prepared according to Examples 1 to 3. Referring to FIG. 3, when the temperature was 650° C., the duration of the heat treatment of SnP₂O₇ pellets prepared according to Examples 1 to 3 were 2 hours, 1 hour, and 3.5 hours, respectively. The SnP₂O₇ pellet prepared according to Example 1 had better ionic conductivity than the SnP₂O₇ pellets prepared according to Examples 2 and 3. Therefore, FIG. 3 confirmed that an optimal time for heat-treating the reaction mixture of SnO₂ hydrate and the phosphoric acid at 650° C. exists.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A proton conductor, comprising SnP₂O₇.

2. A fuel cell, comprising:
a cathode;
an anode; and
an electrolyte membrane,
wherein at least one of the cathode, the anode, and the electrolyte membrane comprises SnP₂O₇.

3. A method of preparing the proton conductor of claim 1, comprising:
reacting SnO₂ or SnO₂ hydrate with a phosphoric acid, and
heat-treating a product of the SnO₂ or SnO₂ hydrate and phosphoric acid reaction.

4. The method of claim 3,
wherein a concentration of the phosphoric acid ranges from about 80 wt % to about 115 wt %.

5. The method of claim 3,
wherein a weight ratio of the SnO₂ to the phosphoric acid ranges from about 1:3 to about 1:1.

6. The method of claim 3,
wherein a temperature of the reaction between SnO₂ or SnO₂ hydrate and the phosphoric acid ranges from about 150° C. to about 450° C.

7. The method of claim 3,
wherein the heat treating is performed at a temperature in a range from about 500° C. to about 800° C.

8. The method of claim 3,
wherein the heat treating is performed for about 1 hour to about 3.5 hours.
